(19) United States
(12) Patent Application Publication
(10) Pub. No.: US 2023/0053390 A1
(43) Pub. Date: Feb. 23, 2023

(54) INFORMATION PROCESSING SYSTEM, INFORMATION PROCESSING APPARATUS, AND METHOD THEREFOR

(71) Applicant: CANON KABUSHIKI KAISHA, Tokyo (JP)

(72) Inventor: Toru Sakaguchi, Osaka (JP)

(21) Appl. No.: 17/820,384

(22) Filed: Aug. 17, 2022

(30) Foreign Application Priority Data
Aug. 20, 2021 (JP) 2021-134622

(51) Int. Cl. G06F 3/14; G06F 9/54

(52) U.S. Cl. CPC G06F 3/1454; G06F 9/54

(57) ABSTRACT

A method performed by an information processing apparatus including a first display unit, and a terminal including a second display unit includes performing display control of screens to be displayed on the first display unit and the second display unit, wherein a first display control and a second display control are switchable in the display control, the first display control controlling a predetermined screen including secure information to be displayed on the first display unit and not to be displayed on the second display unit, and the second display control controlling the predetermined screen including the secure information to be displayed on the second display unit and not to be displayed on the first display unit.

### BACKGROUND OF THE DISCLOSURE

### Field of the Disclosure

The present disclosure relates to a control technique for remotely operating an apparatus.

### Description of the Related Art

There is a function of remote operation for remotely controlling an apparatus. This function is implemented, for example, by using software called Virtual Network Computing (VNC). The VNC server software is activated in advance on a VNC server, and a VNC client activates client software to connect to the server to perform remote operation. The Remote FrameBuffer (RFB) protocol (RFC6143) is used for communications between the VNC server and the VNC client. For example, an apparatus including a VNC server function transmits screen information of an operation screen to an apparatus having a VNC client function. The VNC client apparatus displays the same screen as an operation screen displayed on an operation panel of the VNC server apparatus based on received screen information. A user can cause the VNC server apparatus to execute processing by performing operations on the screen displayed on the VNC client apparatus without operating the operation panel of the VNC server apparatus. In a case where a screen of an apparatus is remotely controlled from another apparatus, when security information such as a password is input, since the security information is displayed on both apparatuses, there is a security risk.

In order to deal with this circumstance, Japanese Patent Application Laid-open No. 2007-115039 discusses a method of not displaying information input on the VNC client on a display unit of the VNC server. In this way, leakage of the security information can be prevented.

In the technique discussed in Japanese Patent Application Laid-open No. 2007-115039, the apparatus used to input the security information is determined in advance and the apparatus on which the security information is not displayed is fixedly determined. However, depending on the situation and the intended use of the remote control, the VNC server apparatus may accept the input of the security information, or the VNC client apparatus may accept the input of the security information. In such a case where the apparatus that accept the security information is not fixedly determined, the technique discussed in Japanese Patent Application Laid-open No. 2007-115039 cannot assure the security.

### SUMMARY OF THE DISCLOSURE

The present disclosure is directed to a technique capable of assuring security in a case where an apparatus that accepts an input of security information during remote control is not fixedly determined.

According to an aspect of the present disclosure, a method performed by an information processing apparatus including a first display unit, and a terminal including a second display unit includes performing display control of screens to be displayed on the first display unit and the second display unit, wherein a first display control and a second display control are switchable in the display control, the first display control controlling a predetermined screen including secure information to be displayed on the first display unit and not to be displayed on the second display unit, and the second display control controlling the predetermined screen including the secure information to be displayed on the second display unit and not to be displayed on the first display unit.

Further features of the present disclosure will become apparent from the following description of exemplary embodiments with reference to the attached drawings.

### BRIEF DESCRIPTION OF THE DRAWINGS

FIG. 1 is a block diagram illustrating an example of a system configuration.

FIG. 2 is a block diagram illustrating an example of a hardware configuration of an image forming apparatus.

FIG. 3 is a block diagram illustrating an example of a software configuration of the image forming apparatus.

FIG. 4 is a block diagram illustrating an example of a hardware configuration of a mobile terminal.

FIG. 5 is a block diagram illustrating an example of a software configuration of the mobile terminal.

FIG. 6 is a diagram illustrating an example of a display/operation unit of the image forming apparatus.

FIG. 7 is a diagram illustrating an example of a home screen.

FIG. 8 is a diagram illustrating an example of a screen flow of screens from a password authentication screen to a security setting screen.

FIG. 9 is a flowchart illustrating an operation flow of screen display processing.

FIGS. 10A and 10B are diagrams illustrating an example of a screen flow displayed on the image forming apparatus (Virtual Network Computing (VNC) server) and an example of a screen flow displayed on a mobile terminal (VNC client).

FIG. 11 is a flowchart illustrating screen display processing.

FIG. 12 is a flowchart illustrating an operation flow of VNC connection processing.

### DESCRIPTION OF THE EMBODIMENTS

Hereinbelow, exemplary embodiments of the present disclosure will be described with reference to the attached drawings. Note that the following exemplary embodiments are not intended to limit the present disclosure according to the range of the claims, and the combinations of features described in the following exemplary embodiments are not necessarily essential. Further, in the following exemplary embodiments, a description will be given of an image forming apparatus as an example of an information processing apparatus. However, it is not limited thereto.

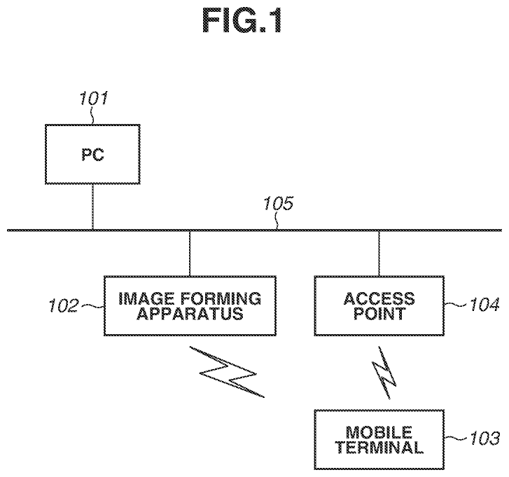

A first exemplary embodiment of the present disclosure will be described. FIG. 1 is a block diagram illustrating an example of an information processing system configuration according to the present exemplary embodiment. An image forming apparatus 102 having a Virtual Network Computing (VNC) server function, a personal computer (PC) 101 that is an information processing apparatus having a VNC client function, and an access point 104 are connected to a Local Area Network (LAN) 105. Further, a mobile terminal 103 that is an information processing apparatus having a VNC client function is connected to the LAN 105 via the access point 104. In a case where the image forming apparatus 102 and the mobile terminal 103 each have a wireless direct communication function, the image forming apparatus 102 and the mobile terminal 103 can communicate with each other directly not via the LAN 105. In the present exemplary embodiment, a description will be given of an example in which the mobile terminal 103 having a VNC client function is connected to the image forming apparatus 102 having a VNC server function using a VNC connection. However, the VNC client to be connected to the VNC server may be another apparatus such as the PC 101 and another image forming apparatus (not illustrated), as long as the apparatus has a VNC client function.

Hereinbelow, the image forming apparatus 102 operating as a VNC server is also referred to as a server, and the information processing apparatus, such as the PC 101 and the mobile terminal 103, to be connected to the server using a VNC connection is also referred to as a client.

The image forming apparatus 102 having a VNC server function transmits, to a client, screen information corresponding to a screen displayed on a display unit of the image forming apparatus 102. The client having obtained the screen information displays a screen corresponding to the screen displayed on the image forming apparatus 102. When an operation is performed on the screen displayed on the client, the operation information is transmitted to the image forming apparatus 102, and the image forming apparatus 102 performs processing in response to the operation. In other words, the client can perform remote operation of the image forming apparatus 102 by performing VNC connection to the image forming apparatus 102. In the present exemplary embodiment, only one client can connect to and operate the server at a time, but a plurality of clients may connect to the server.

First, the image forming apparatus 102 activates VNC server software. Then, the image forming apparatus 102 waits for a connection request from a client. Next, the mobile terminal 103 activates VNC client software. Then, the mobile terminal 103 connects to a desired server by a user's operation or the like. The communication between the server and the client is performed in accordance with the Remote FrameBuffer (RFB) protocol. First, the RFB protocol performs handshake processing. Then, after the handshake processing is completed, the RFB protocol performs transmission/reception of screen information or operation information.

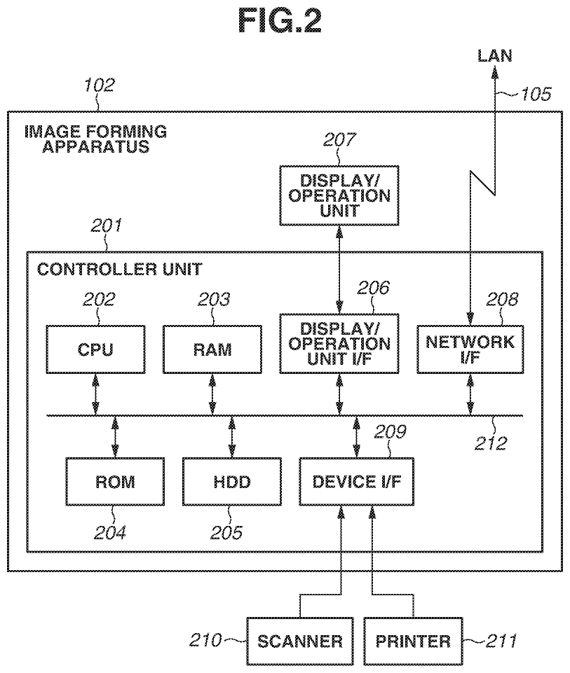

FIG. 2 is a block diagram illustrating a hardware configuration of the image forming apparatus 102. A central processing unit (CPU) 202 in a controller unit 201 of the image forming apparatus 102 is an arithmetic device for controlling the entire system of the image forming apparatus 102. The CPU 202 performs overall control of devices connected to a system bus 212.

A read-only memory (ROM) 204 is a non-volatile memory for storing image data and other kinds of data, and various programs required for the CPU 202 to operate.

A random access memory (RAM) 203 is a volatile memory used as a main memory for the CPU 202 and a temporary storage area such as a work area. In addition, data and a program such as an operating system (OS), system software, and application software are loaded into the RAM 203.

The CPU 202 controls each unit in the image forming apparatus 102 by loading a program stored in the ROM 204 into the RAM 203 and executing the loaded program. The program for the CPU 202 to operate is not limited to the program stored in the ROM 204, and a program stored in a hard disk drive (HDD) 205 and the like in advance may be used.

The HDD 205 stores the OS, the system software, the application software, image data, and setting data.

However, another storage device such as a solid state drive (SSD), a Secure Digital (SD) memory card, and an embedded MultiMediaCard (eMMC) may be used as long as it can store data.

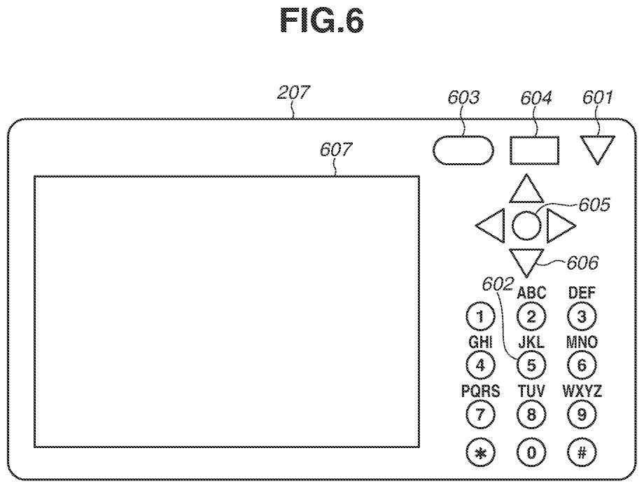

A display/operation unit I/F 206 is an interface unit with a display/operation unit 207 for outputting information to be displayed on the display/operation unit 207 to the display/operation unit 207. Further, the display/operation unit I/F 206 accepts information input by a user via the display/operation unit 207. The display/operation unit 207 includes hardware keys 601 to 606 for receiving user's operations. The hardware keys 601 to 606 are keys that can be physically pressed, such as numerical keys, a start key, and a stop key. When the key is pressed, corresponding information is notified to the display/operation unit I/F 206. Further, the display/operation unit 207 includes a display 607 (see FIG. 6) for displaying images. The display 607 receives a Graphical User Interface (GUI) screen generated by the CPU 202 from the display/operation unit I/F 206 and displays the received GUI screen thereon.

A network I/F 208 connects to a Local Area Network (LAN) 105 to communicate with the PC 101 and image forming apparatuses (not illustrated) that are connected to the LAN 105, and performs input/output of information with the mobile terminal 103 via the access point 104.

A device I/F 209 connects the controller unit 201 with a scanner 210 serving as an image input device and a printer 211 serving as an image output device, to input and output image data. In other words, the scanner 210 functions as a scanner to scan a document, and the printer 211 functions as a printer to print image data on a sheet.

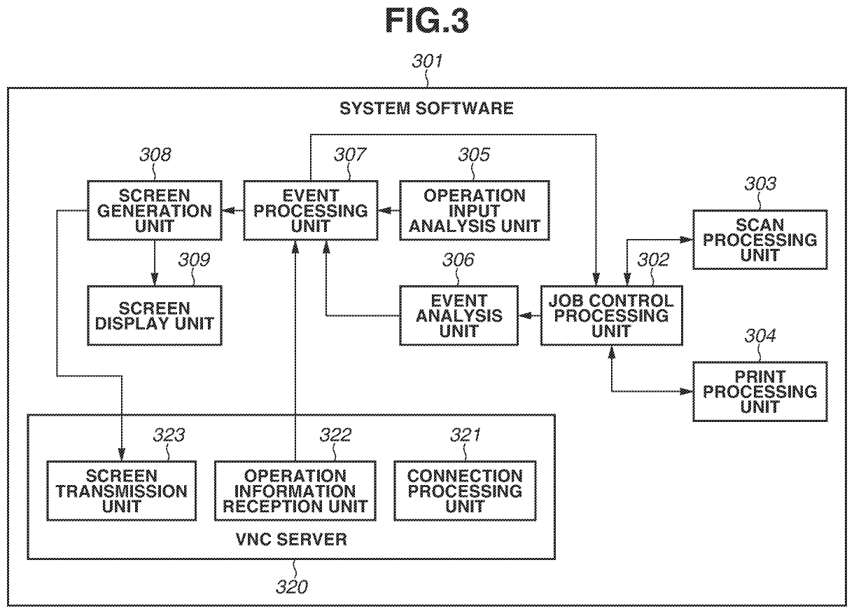

FIG. 3 is a block diagram illustrating a software configuration of the image forming apparatus 102. System software 301 is stored in a storage unit such as the RAM 203, the ROM 204, and the HDD 205, and executed by the CPU 202.

A job control processing unit 302 controls software modules including not-illustrated software modules to control jobs to be executed by the image forming apparatus 102, such as a copy job, a print job, and a scan job.

A scan processing unit 303 controls, based on an instruction by the job control processing unit 302, the scanner 210 via the device I/F 209 to read a document set on a document platen of the scanner 210.

A print processing unit 304 controls, based on an instruction by the job control processing unit 302, the printer 211 via the device I/F 209 to print a designated image.

An operation input analysis unit 305 analyzes information input from the display/operation unit 207 via the display/operation unit I/F 206 to notify an event processing unit 307 of an event corresponding to the user's operation. The information to be analyzed by the operation input analysis unit 305 is, for example, operation information indicating pressing of a hardware key by a user.

An event analysis unit 306 receives various types of events, from the job control processing unit 302 or the like, that occur in the image forming apparatus 102 other than the operation input, and analyzes the received event to notify the event processing unit 307 of the event corresponding to the analyzed event. The various types of events to be analyzed by the event analysis unit 306 are events other than the events generated by the user's operation such as the end of job and the shortage of printing paper.

The event processing unit 307 receives an event from the operation input analysis unit 305, the event analysis unit 306, or an operation information reception unit 322. The event processing unit 307 notifies the job control processing unit 302, a screen generation unit 308, or a software keyboard control unit of the event, according to the event, to control each unit of the image forming apparatus 102.

The screen generation unit 308 performs processing of generating on the RAM 203 data for the screen to be displayed on the display unit of the display/operation unit 207 or an external apparatus. The screen generation unit 308 updates screen data to be displayed on the server and screen data to be displayed on the client based on the operation from the server or the client, or the change of status. The screen display is updated by displaying the updated screen data on the server and the client via a screen display unit 309 and a screen transmission unit 323.

The screen display unit 309 reads the screen data generated by the screen generation unit 308 from the RAM 203 and performs display control to display the screen data on the display 607 of the display/operation unit 207 via the display/operation unit I/F 206.

A VNC server 320 is a software module for communicating with the client via the LAN 105. For example, the VNC server 320 communicates with a VNC client 520 operating on the mobile terminal 103 and performs processing for accepting remote control.

A connection processing unit 321 receives a connection request, for example, from a connection processing unit 521 in the VNC client 520, and performs connection control.

The operation information reception unit 322 receives operation information, for example, from an operation information transmission unit 522 in the VNC client 520, and notifies the event processing unit 307 of the event corresponding to the user's operation.

In addition, the event notified by the operation information reception unit 322 is equivalent to the event notified by the operation input analysis unit 305, and is the event for the user to operate the image forming apparatus 102.

The screen transmission unit 323 performs processing of reading screen data generated by the screen generation unit 308 from the RAM 203 and of transmitting the read screen data to a screen reception unit 523 of the VNC client 520.

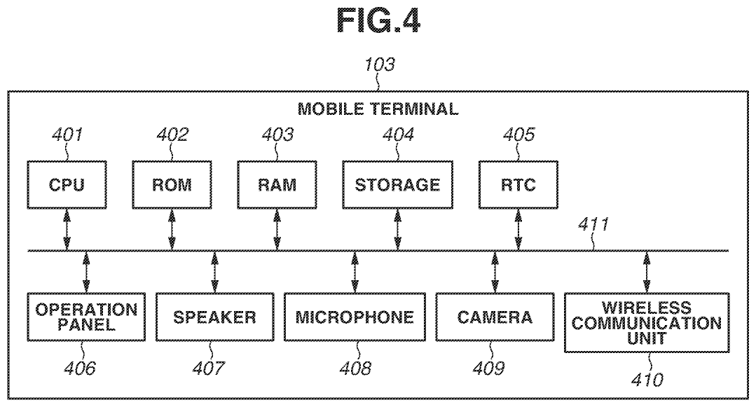

FIG. 4 is a block diagram illustrating a hardware configuration of the mobile terminal 103. A CPU 401 in the mobile terminal 103 is an arithmetic device for controlling the entire system of the mobile terminal 103. The CPU 401 performs overall control of devices connected to a system bus 411.

A ROM 402 is a non-volatile memory to store image data and other data, various programs required for the CPU 401 to operate.

A RAM 403 is a volatile memory used as a main memory for the CPU 401 and a temporary storage area such as a work area. In addition, data and programs such as an OS, system software, and application software are loaded into the RAM 403 when necessary.

The CPU 401 controls each unit in the mobile terminal 103 by loading a program stored in the ROM 402 or the like into the RAM 403 and executing the loaded program. The program for the CPU 401 to operate is not limited to the program stored in the ROM 402, and a program stored in a storage 404 and the like in advance may be used.

The storage 404 stores an OS, system software, application software, pictures and electronic documents, and setting data. However, another storage device such as an SSD, an SD memory card, and an eMMC may be used as long as it can store data.

A Real Time Clock (RTC) 405 is a timer unit for counting time.

An operation panel 406 is provided with a touch panel function that detects the user's touch operation, and displays various types of screens provided by an OS 530 and a multifunction peripheral (MFP) application 502. A user can input a desired operation instruction to the mobile terminal 103 by inputting a touch operation on the operation panel 406.

A speaker 407 and a microphone 408 are used by a user, for example, when the user makes a telephone call with another mobile terminal or a land-line telephone.

A camera 409 captures an image in response to a user's image capturing instruction. The image captured by the camera 409 is stored in a predetermined area of the storage 404.

A wireless communication unit 410 performs wireless communication via a wireless LAN or the like.

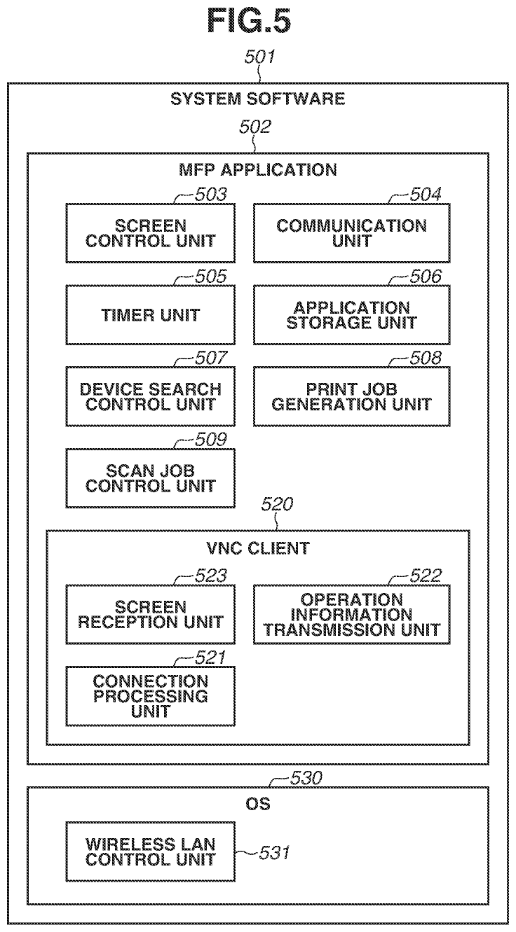

FIG. 5 is a block diagram illustrating a software configuration of the mobile terminal 103. System software 501 is stored in a storage unit of any of the RAM 403, the ROM 402, and the storage 404, and executed by the CPU 401.

The OS 530 is software for controlling the operation of the entire mobile terminal 103.

Various applications including the MFP application 502 to be described below can be installed in the mobile terminal 103. The OS 530 exchanges information with these applications and changes the screen to be displayed on the operation panel 406 based on instructions received from the applications. Further, the OS 530 is provided with a device driver group for controlling various kinds of hardware and provides, to the applications operating on the OS 530, an Application Programming Interface (API) for using various kinds of hardware. The device driver group includes a wireless LAN control unit 531 in the present exemplary embodiment.

The wireless LAN control unit 531 is a device driver for controlling the wireless communication unit 410.

The MFP application 502 is an application installed in the mobile terminal 103. A print instruction and a scan instruction to image forming apparatuses such as the image forming apparatus 102, and a remote control of the operation screen of the image forming apparatus can be performed using the MFP application 502. Although various applications other than the MFP application 502 are installed in the mobile terminal 103, descriptions thereof are omitted.

Further details of the software configuration of the MFP application 502 will be described.

A screen control unit 503 controls a screen to be displayed on the operation panel 406 via the OS 530. The screen control unit 503 displays an MFP application screen on the operation panel 406. Further, the screen control unit 503 determines an operation instruction input by a user via the operation panel 406. Further, the screen control unit 503 reads image data stored in the application storage unit 506 by the screen reception unit 523 and displays the read image data on the operation panel 406 via the OS 530.

A communication unit 504 transmits and receives a command by controlling wireless communications by the wireless communication unit 410 via the OS 530.

A timer unit 505 counts time.

The application storage unit 506 temporarily stores in the RAM 403 various information used for executing the MFP application 502.

A device search control unit 507 generates search data for searching the image forming apparatus 102 to connect to, and transmits the search data to the devices on the LAN 105 by the wireless communication unit 410 to receive a response from the corresponding image forming apparatus 102. The search data may be broadcasted to all the devices on the LAN 105 or may be transmitted with an address of a device designated.

A print job generation unit 508 generates a print job. The print job generated by the print job generation unit 508 is transmitted to the image forming apparatus 102 by the wireless communication unit 410, and is printed by the image forming apparatus 102.

A scan job control unit 509 issues a scan instruction to the image forming apparatus 102 via the wireless communication unit 410, and displays scan data received from the image forming apparatus 102. The scan data is stored in the application storage unit 506 if necessary.

The VNC client 520 is a software module for performing remote control of the image forming apparatus 102 by communicating, via the LAN 105, with the VNC server 320 operating on the image forming apparatus 102.

The connection processing unit 521 transmits a connection request to the connection processing unit 321 of the VNC server 320 in response to a reception of a request from a user to perform connection processing.

The operation information transmission unit 522 receives from the screen control unit 503 an operation instruction input by the user via the operation panel 406, and transmits the operation instruction to the operation information reception unit 322 of the VNC server 320.

The screen reception unit 523 receives screen data from the screen transmission unit 323 of the VNC server 320 and stores the screen data in the application storage unit 506.

The communication between the VNC server 320 and the VNC client 520 is implemented by the CPU 202 and the CPU 401 respectively controlling the network I/F 208 and the wireless communication unit 410.

Through the processing performed as described above by the software modules, the same screen as that displayed on the display 607 of the display/operation unit 207 in the image forming apparatus 102 is also displayed on the operation panel 406 of the mobile terminal 103. Then, the user can cause the image forming apparatus 102 to perform various kinds of processing remotely by performing operations using the operation panel 406 of the mobile terminal 103.

FIG. 6 is a schematic view illustrating the display/operation unit 207 of the image forming apparatus 102. The display 607 and the hardware keys 601 to 606 are adjacently arranged on the display/operation unit 207.

Various kinds of buttons to be operated by a user will be described. For example, a stop key 601 is used to stop the operation at work. Ten keys 602 include buttons of numerals and letters, and used, for example, to input time and a password, and to instruct a screen switching of the display 607. One or a plurality of numerals or letters is assigned to each key of the ten keys 602, and, for example, characters of “2”, “A”, “B”, “C”, “a”, “b”, and “c” are assigned to “2” key. On the character input screen, if the input mode is, for example, an alphabet capital letter mode, the input letter is shifted in the order of “A”, “B”, “C”, “A”, and “B” . . . each time a user presses the “2” key. A home key 603 is used to call a home screen to be described below. A return key 604 is used to shift the screen display of the display 607 to a previously displayed screen. A determination button 605 is used to determine an item selected on the display 607 or to press a selected button. A cross key 606 is used to move the position of a cursor or a focus on the display 607 from right to left or up and down.

These various kinds of buttons are merely an example, and a button not described above may be provided. Further, functions of the various buttons may be different from those described above.

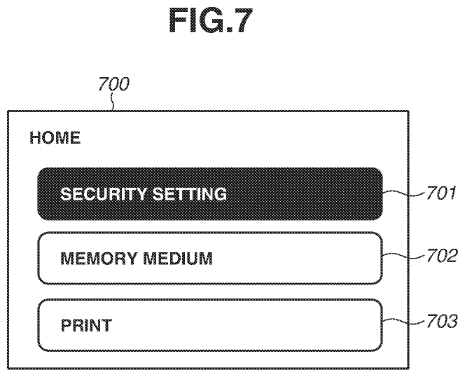

FIG. 7 illustrates an example of a home screen to be displayed on the display 607 when the operation of the image forming apparatus 102 is started or the home key 603 is pressed. A home screen 700 is a screen for displaying function buttons 701 to 703 each corresponding to an application installed in the image forming apparatus 102 or a function.

In FIG. 7, a security setting button 701, a memory medium button 702, and a print button 703 are displayed as an example, and among these buttons, a focus is placed on the security setting button 701.

The function buttons 701 to 703 are buttons for activating an application or a function. When a user selects a button by touch operation or operating any of the hardware keys 601 to 606, the CPU 202 activates an application or a function associated with the selected button. When a security setting button 701 is selected, the screen shifts to a password authentication screen 800. Then, when the password input and the authentication are completed, the screen shifts to a security setting screen 805 of the image forming apparatus 102. When a memory medium button 702 is pressed, the screen shifts to a screen for printing an image file stored in a universal serial bus (USB) memory (not illustrated) connected to a USB memory slot (not illustrated) of the image forming apparatus 102.

When a print button 703 is pressed, the screen can shift to a screen for printing a print job input in the image forming apparatus 102 by a user via the PC 101 or another apparatus.

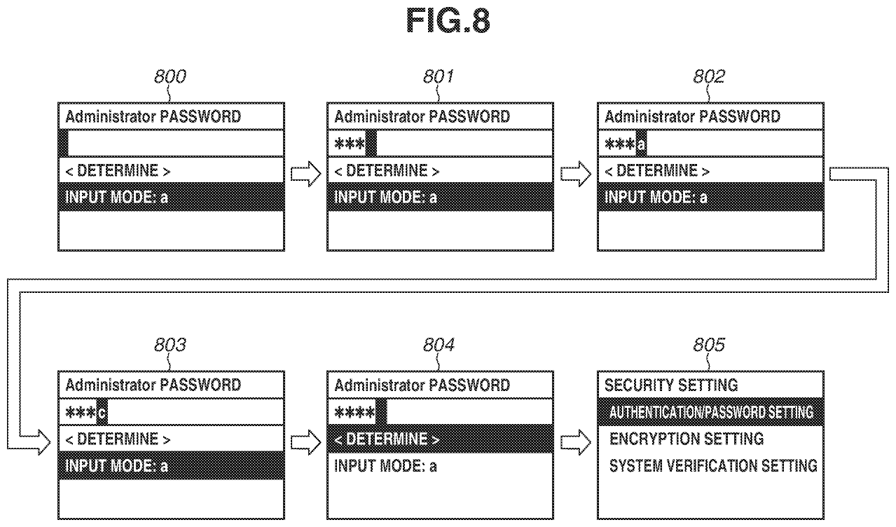

FIG. 8 is an example of a screen flow from the password authentication screen 800 to the security setting screen 805 to be displayed on the display 607 of the image forming apparatus 102 when the security setting button 701 is selected on the home screen 700.

A user that can perform the setting on the security setting screen 805 is desirably limited to only an administrator due to the characteristics of the setting contents. For this reason, password authentication screens 800 to 804 are displayed immediately before the screen shift, and only when the authentication is successful, the screen shifts to the security setting screen 805.

In the present exemplary embodiment, input of letters, such as a password, and movement of a cursor along therewith are performed using the ten keys 602, the cross key 606, and the determination button 605. However, it is not limited thereto. For example, a touch operation on the operation panel may be used for inputting characters and moving a cursor. In addition, each character for security information such as a password is generally displayed in a hidden manner with asterisk “*” when it is input. In the present exemplary embodiment, the input character is not displayed like “*” immediately after it is input, but after a predetermined time has passed without the same key as that used for inputting the password being pressed, or after another key is pressed, the character changes to “*”. This is a specification for a user to be able to recognize the character input using the ten keys 602. Several characters are assigned to each key of the ten keys 602, and if the input character is changed to “*” immediately after being input, it is difficult for the user to recognize the input character.

The user can change the mode of characters to be input (e.g., uppercase alphabet letters, lowercase alphabet letters, numerals) by selecting “INPUT MODE:” on the password authentication screen 800. Further, the user performs authentication operation by selecting “<DETERMINE>” after inputting the password.

A password authentication screen 801 is a screen illustrating a state where three characters are input on the password authentication screen 800.

A password authentication screen 802 is a screen displayed immediately after the “2” key corresponding to a letter “a” in the ten keys 602 is pressed once on the password authentication screen 801. Since the fourth letter is immediately after being input, it is displayed as “a” not “*”.

A password authentication screen 803 is a screen displayed immediately after the “2” key corresponding to a letter “a” in the ten keys 602 is pressed two times more continuously on the password authentication screen 802. The fourth letter displayed as “a” on the password authentication screen 802 is changed to “b” and then to “c” as the key is pressed twice.

A password authentication screen 804 is a screen displayed immediately after a predetermined time period has elapsed without the same key used for inputting the password, i.e., the “2” key being pressed. The fourth letter, which is displayed as “c” on the password authentication screen 803, is changed to “*” because the predetermined time period has elapsed without the same key being pressed.

The user who has completed the password input on the password authentication screen 804 selects “<DETERMINE>”. Then, only in a case where the input password is correct, the screen shifts to the security setting screen 805. In a case where the input password is not correct, i.e., the authentication is not successful, an error screen is displayed.

A description will be given of a case where an image forming apparatus, on which the input character string is displayed when the security information such as a password is input, is remotely controlled from an external terminal using the VNC. For example, when a password is input on an external terminal serving as a VNC client, the input password is displayed on the display of the image forming apparatus serving as a VNC server. Accordingly, there is a risk that the password may be seen by another user standing in front of the image forming apparatus. In addition, if a password is input on the display of the image forming apparatus serving as a VNC server, the password is displayed on the external terminal serving as a VNC client. In a case of supporting a user who is operating the image forming apparatus in front of the image forming apparatus from an external terminal, another user who is supporting the user can see a password input by the user who is operating the image forming apparatus. In a case where the image forming apparatus is remotely controlled, it is desirable to display the security information only on the side of the apparatus being operated.

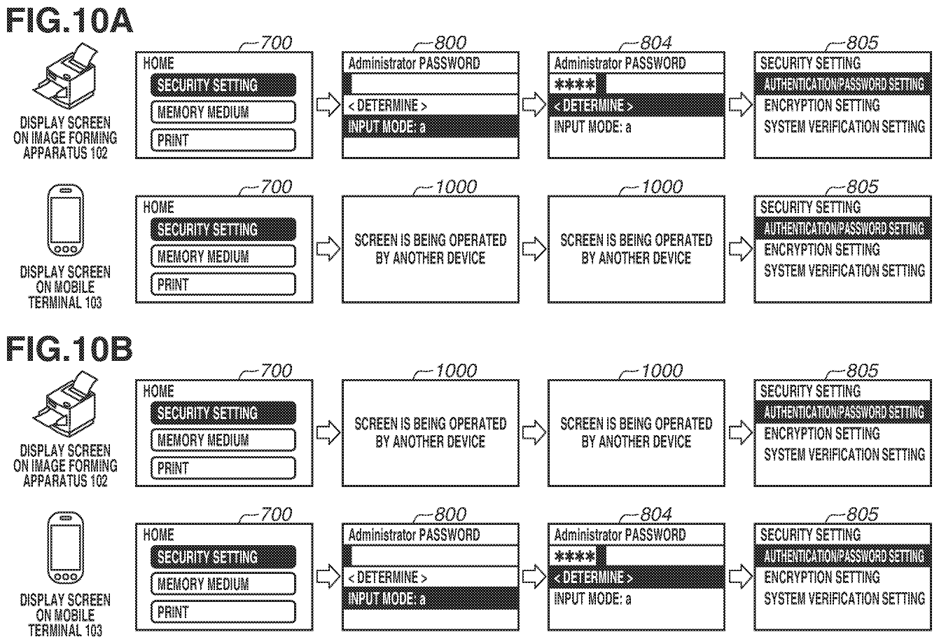

FIG. 10A illustrates examples of a flow of a screen displayed on the display/operation unit 207 of the image forming apparatus 102 serving as a VNC server, and of a flow of a screen displayed on the operation panel 406 of the mobile terminal 103 serving as a VNC client in a case where the screen of the image forming apparatus 102 shifts to the password authentication screen 800 as a result of the operation on the display/operation unit 207 of the image forming apparatus 102, according to the present exemplary embodiment.

In a case where the screen is not a screen to input security information, for example, the home screen 700 is displayed on both of the image forming apparatus 102 and the mobile terminal 103. When the security setting button 701 is selected on the image forming apparatus 102, the password authentication screen 800 is displayed on the image forming apparatus 102. On the other hand, on the mobile terminal 103, the password authentication screen 800 is not displayed and instead a notice screen 1000 indicating that the screen is being operated by another device is displayed. In the present exemplary embodiment, the notice screen 1000 is displayed on the mobile terminal 103 while the image forming apparatus 102 is receiving a password input to the password authentication screen 800. Then, the security setting screen 805 is displayed on both of the image forming apparatus 102 and the mobile terminal 103, in a case where the password input is performed on the image forming apparatus 102, the authentication is successful, and the screen shifts to the security setting screen 805.

FIG. 10B illustrates examples of a flow of a screen displayed on the display/operation unit 207 of the image forming apparatus 102 serving as a VNC server, and of a flow of a screen displayed on the operation panel 406 of the mobile terminal 103 in a case where the screen of the mobile terminal 103 shifts to the password authentication screen 800 as a result of the operation on the operation panel 406 of the mobile terminal 103 serving as a VNC client, according to the present exemplary embodiment. In a case where the screen is not a screen to input security information, the home screen 700 is displayed on both of the image forming apparatus 102 and the mobile terminal 103. When the security setting button 701 is selected on the mobile terminal 103, the password authentication screen 800 is displayed on the mobile terminal 103. On the other hand, on the image forming apparatus 102, the password authentication screen 800 is not displayed and instead the notice screen 1000 indicating that the screen is being operated by another device is displayed. In the present exemplary embodiment, the notice screen 1000 is displayed on the image forming apparatus 102 while the mobile terminal 103 is receiving a password input to the password authentication screen 800. Then, the security setting screen 805 is displayed on both of the image forming apparatus 102 and the mobile terminal 103, in a case where the password input is performed on the mobile terminal 103, the authentication is successful, and the screen shifts to the security setting screen 805.

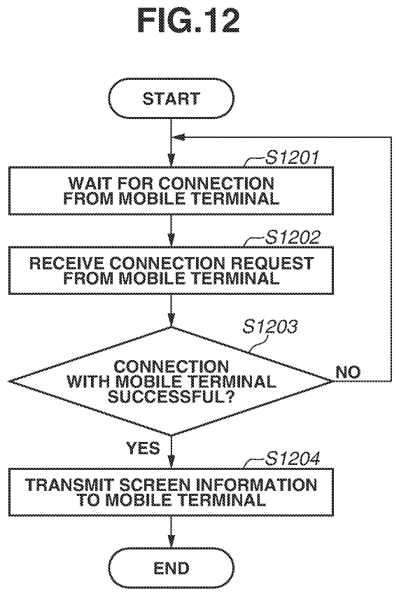

FIG. 12 is a flowchart illustrating processing performed by the VNC server 320 of the image forming apparatus 102 according to the present exemplary embodiment. This flowchart is implemented by the CPU 202 reading into the RAM 203 a program for implementing each control module stored in the ROM 204 or the HDD 205 and executing the read program.

When a user turns on the image forming apparatus 102, the VNC server 320 is activated by the system software 301 in the image forming apparatus 102. In step S1201, the connection processing unit 321 opens a port for the VNC connection and waits for a connection from a VNC client, in the VNC server activation processing.

In step S1202, a remote operation function by the VNC starts when the user operates the mobile terminal 103, and when the mobile terminal 103 requests the VNC connection with the image forming apparatus 102, the connection processing unit 321 receives the connection request from the VNC client. In step S1203, the CPU 202 determines whether the VNC connection is successful. In a case where the VNC connection is successful (YES in step S1203), the processing proceeds to step S1204. On the other hand, in a case where the VNC connection is not successful (NO in step S1203), the processing returns to step S1201 to repeat the processing. When the VNC connection is successful (YES in step S1203), in step S1204, the screen display unit 309 displays the screen generated by the screen generation unit 308 on the display 607 of the display/operation unit 207, and the screen transmission unit 323 transmits information of the screen to the mobile terminal 103. With this processing, the same screen as that displayed on the image forming apparatus 102 can be displayed on the mobile terminal 103. Then, the screen on the image forming apparatus 102 can be operated by operating the image forming apparatus 102 or the mobile terminal 103.

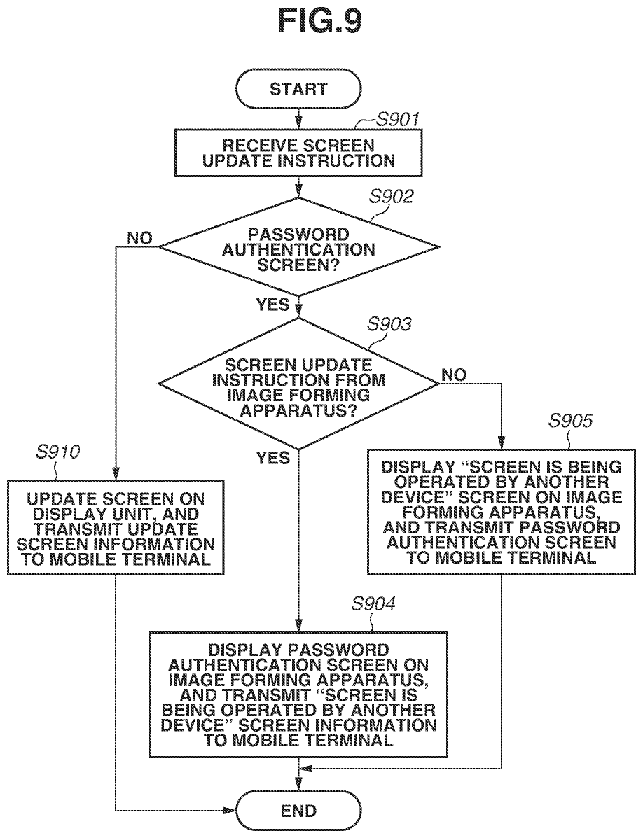

FIG. 9 is a flowchart illustrating update processing of the display screen on the image forming apparatus 102 in a case where the image forming apparatus 102 and the mobile terminal 103 are in the VNC connection, according to the present exemplary embodiment. In addition, this flowchart is implemented by the CPU 202 executing a program related to display screen control processing stored in the ROM 204 or the like.

In step S901, the CPU 202 receives an update instruction for the screen to be displayed on the display/operation unit 207 of the image forming apparatus 102. More specifically, the CPU 202 accepts a touch operation or an operation onto the hardware keys 601 to 606 on the image forming apparatus 102. Alternatively, the CPU 202 accepts operation information corresponding to the operation received on the mobile terminal 103 serving as a VNC client. The processing performed in step S902 and the subsequent steps are performed repeatedly each time the screen is updated.

In step S902, the screen display unit 309 determines whether the screen displayed by the screen update is a screen to input security information, i.e., a password authentication screen 800. If the screen is the password authentication screen 800 (YES in step S902), the processing proceeds to step S903. If the screen displayed by the update is not the password authentication screen 800 (NO in step S902), the processing proceeds to step S910. In step S910, the screen display unit 309 displays the screen to be updated on the display/operation unit 207, and the screen transmission unit 323 transmits the screen information of the screen to the mobile terminal 103 serving as a VNC client.

In step S903, the event processing unit 307 determines whether the update instruction in step S901 is received by the image forming apparatus 102 serving as a VNC server. When the event processing unit 307 determines that the update instruction is received by the image forming apparatus 102 (YES in step S903), the processing proceeds to step S904. In step S904, the screen display unit 309 displays the password authentication screen 800 on the display/operation unit 207, and the screen transmission unit 323 transmits information of the notice screen 1000 indicating that the screen is being operated by another device to the mobile terminal 103 serving as a VNC client. Then, the notice screen 1000 is displayed on the mobile terminal 103 as illustrated in FIG. 10A. In the above description, the information of the notice screen 1000 is transmitted from the image forming apparatus 102 to the mobile terminal 103. However, it is not limited thereto, and the mobile terminal 103 may receive predetermined information from the image forming apparatus 102 to generate the notice screen 1000 based on the received predetermined information. Further, the password authentication screen 800 may be displayed on the display/operation unit 207, and the screen transmission unit 323 may not transmit the updated screen information to the VNC client. In this case, the password authentication screen 800 is displayed on the image forming apparatus 102, and a screen before shifting to the password authentication screen is displayed on the mobile terminal 103.

In step S903, when the event processing unit 307 determines that the update instruction is accepted by the mobile terminal 103 serving as a VNC client (NO in step S903), the processing proceeds to step S905. In step S905, the screen display unit 309 displays on the display/operation unit 207 of the image forming apparatus 102 the notice screen 1000 indicating that the screen is being operated by another device, and the screen transmission unit 323 transmits information of the password authentication screen 800 to the mobile terminal 103 serving as a VNC client. Then, the password authentication screen 800 is displays on the mobile terminal 103 as illustrated in FIG. 10B.

Through the above-described processing, the security is assured because the screen to input the security information is displayed only on the apparatus that has accepted the instruction to shift to the screen for inputting the security information. More specifically, when the security setting button 701 is selected on the image forming apparatus 102, the password authentication screen 800 is displayed only on the image forming apparatus 102, and when the security setting button 701 is selected on the mobile terminal 103, the password authentication screen 800 is displayed only on the mobile terminal 103. In the present exemplary embodiment, the description has been given of the example in which the password authentication screen 800 is displayed only on the apparatus that causes the screen to shift to the password authentication screen 800. However, it is not limited thereto as long as the security can be assured. For example, the password authentication screen 800 before the password is input is displayed on both of the image forming apparatus 102 and the mobile terminal 103, and when the first letter of the password is input, the input letter (e.g., “a”) is displayed only on the apparatus that has accepted the input, and when the input letter has been fixed and the input letter has changed to “*”, the password authentication screen on which “*” is displayed may be displayed on both of the image forming apparatus 102 and the mobile terminal 103.

In addition, the flowchart is described above on the premise that the screen update occurs when the image forming apparatus 102 and the mobile terminal 103 are in the VNC connection. However, a flowchart that is not based on the VNC connection may be provided. In this case, when an instruction to update a screen to be displayed on the display/operation unit 207 of the image forming apparatus 102 is received in step S901, the CPU 202 determines whether the image forming apparatus 102 and the mobile terminal 103 are in the VNC connection, and in a case where the CPU 202 determines that they are in the VNC connection, the processing proceeds to step S902 and the subsequent steps. If they are not in the VNC connection, the screen is displayed on the display/operation unit 207 even if it is the password authentication screen 800.

A second exemplary embodiment will be described. In the first exemplary embodiment, the security information is prevented from being illicitly seen because the password authentication screen is displayed only on the screen on which a password is being input. However, even if the password authentication screen is displayed only on one apparatus, the operation of the screen itself can be performed on a VNC server and a VNC client. For example, when a user A is performing a password input operation on a mobile terminal serving as a VNC client, if another user B operates a hardware key on the image forming apparatus 102, an input not intended by the user A may be performed. To solve this issue, in the present exemplary embodiment, a description will be given of an example in which only the apparatus that is accepting the password input can accept the operation. A basic structure of the present exemplary embodiment is the same as that of the first exemplary embodiment, and thus only the different portions will be described.

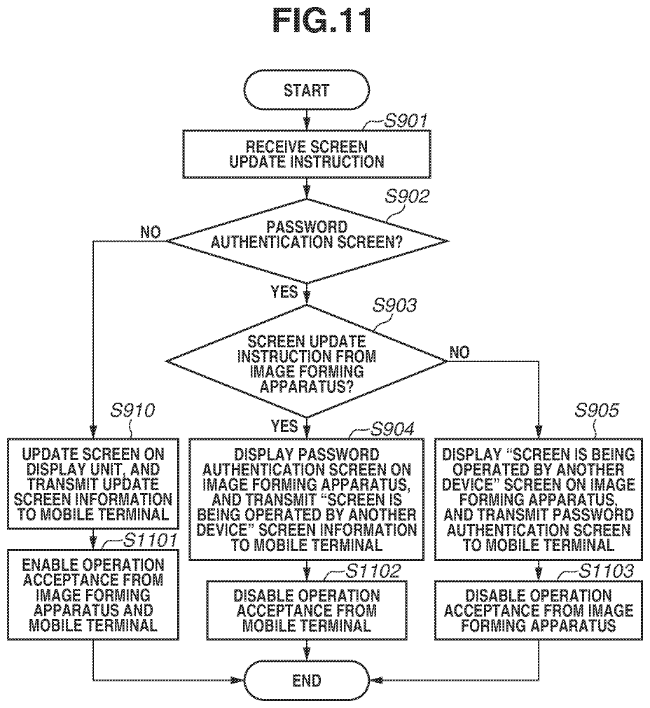

FIG. 11 is a flowchart illustrating update processing of the display screen while the image forming apparatus 102 and the mobile terminal 103 are in the VNC connection, according to the present exemplary embodiment. In addition, this flowchart is implemented by the CPU 202 executing a program related to display screen control processing stored in the ROM 204. A basic structure of the flowchart in FIG. 11 is similar to that in FIG. 9, and thus only the different portions will be described.

In step S910, the screen display unit 309 displays an update destination screen on the display/operation unit 207 and transmits screen information of the update destination to the mobile terminal 103 serving as a VNC client. In step S1101, the event processing unit 307 is set to a state where operation instructions can be received from both of the image forming apparatus 102 serving as a VNC server, and the mobile terminal 103 serving as a VNC client. In other words, the instructions from the VNC server and the client can be accepted on the screen other than the password authentication screen.

In step S1102, the operation acceptance from the mobile terminal 103 serving as a VNC client is set to be disabled. More specifically, for example, the operation information reception unit 322 of the VNC server 320 of the image forming apparatus 102 controls the operation information received from the operation information transmission unit 522 of the VNC client 520 not to be transmitted to the event processing unit 307.

In step S1103, the operation acceptance from the image forming apparatus 102 serving as a VNC server is set to be disabled. More specifically, the operation input analysis unit 305 of the image forming apparatus 102 controls information supplied from the display/operation unit 207 via the display/operation unit I/F 206 not to be transmitted to the event processing unit 307.

Through the above-described processing, since the input operation is acceptable only on the apparatus being used to input the password, the operation is prevented from being disturbed by other users.

Further, in the examples described above, the screen to input the security information has been described. However, it is not limited thereto.

The present exemplary embodiment is applicable to any screen as long as the screen is for inputting a character string. In other words, the system is configured to accept the input operation only by the apparatus that is accepting the input, and the operation on the other apparatus is disabled.

### OTHER EXEMPLARY EMBODIMENTS

In the above-described exemplary embodiment, the example in which the input password is displayed on the screen is described. However, it is not limited thereto. For example, the present disclosure is applicable to a case where, when the password is input using a software keyboard, the display of the software key touched by the user is changed (e.g., highlighted) to be distinguishable by the user. In a case where the apparatus is remotely controlled via the VNC, if the touched software key is highlighted on both of the VNC server and the VNC client, the security information may leak out. In this case, the security information leak can be prevented by highlighting the touched software key only on the apparatus that is accepting the user's operation, and not highlighting the touched software key on the other apparatus.

Further, the present disclosure can be realized by executing the following processing. Specifically, software (computer program) to realize the exemplary embodiments described above is supplied to a system or an apparatus via a network or various kinds of storage media, and a computer (CPU or MPU) of the system or the apparatus reads and executes the computer program. In this case, the computer program and the storage medium storing the program constitute the present disclosure.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2021-134622, filed Aug. 20, 2021, which is hereby incorporated by reference herein in its entirety.

What is claimed is:

1. A method performed by an information processing apparatus including a first display unit, and a terminal including a second display unit, the method comprising:
performing display control of screens to be displayed on the first display unit and the second display unit,
wherein a first display control and a second display control are switchable in the display control, the first display control controlling a predetermined screen including secure information to be displayed on the first display unit and not to be displayed on the second display unit, and the second display control controlling the predetermined screen including the secure information to be displayed on the second display unit and not to be displayed on the first display unit.

2. The method according to claim 1, further comprising:
controlling, in the display control, in a case where the information processing apparatus receives an operation to display the predetermined screen, the predetermined screen to be displayed on the first display unit, and controlling information of the predetermined screen without transmitting to the terminal; and
controlling, in a case where the terminal receives an operation to display the predetermined screen, the information of the predetermined screen to be transmitted to the terminal without displaying on the first display unit.

3. The method according to claim 1, wherein the predetermined screen is a screen to input security information.

4. The method according to claim 1, wherein the predetermined screen is a screen on which a password is to be displayed.

5. The method according to claim 1, further comprising:
controlling, in the display control, in a case where the information processing apparatus receives an operation to display the predetermined screen, the predetermined screen to be displayed on the first display unit, and controlling a screen different from the predetermined screen to be displayed on the second display unit; and
controlling, in a case where the terminal receives an operation to display the predetermined screen, the predetermined screen to be displayed on the second display unit, and controlling a screen different from the predetermined screen to be displayed on the first display unit.

6. The method according to claim 1, wherein a notice indicating that an operation is being received on another apparatus is displayed on the screen different from the predetermined screen.

7. The method according to claim 1, further comprising controlling, in the display control, in a case where an operation to display a screen different from the predetermined screen is received by the information processing apparatus or the terminal, the screen different from the predetermined screen to be displayed on the first display unit and the second display unit.

8. The method according to claim 1, wherein the information processing apparatus functions as a Virtual Network Computing (VNC) server and the terminal functions as a VNC client.

9. The method according to claim 1, wherein the information processing apparatus is an image forming apparatus including at least one of a print function and a scan function.

10. The method according to claim 1, further comprising:
controlling, in a case where the information processing apparatus receives an operation to display the predetermined screen, an operation to the predetermined screen is accepted by the information processing apparatus without accepting at the terminal, and
controlling, in a case where the terminal receives an operation to display the predetermined screen, an operation to the predetermined screen is accepted by the terminal without accepting by the information processing apparatus.

11. The method according to claim 1, wherein, in a case where the terminal receives an operation, corresponding operation information is transmitted from the terminal to the information processing apparatus, and the information processing apparatus executes processing based on the operation information.

12. An apparatus including a first display unit and configured to communicate with a terminal including a second display unit, the apparatus comprising:
a memory; and
at least one processor in communication with the memory,
wherein the at least one processor performs display control of screens to be displayed on the first display unit and the second display unit,
wherein a first display control and a second display control are switchable in the display control, the first display control controlling a predetermined screen including secure information to be displayed on the first display unit and not to be displayed on the second display unit, and the second display control controlling the predetermined screen including the secure information to be display on the second display unit and not to be displayed on the first display unit.

13. The apparatus according to claim 12,
wherein, in the display control, in a case where the apparatus receives an operation to display the predetermined screen, the at least one processor controls the apparatus to display the predetermined screen on the first display unit without transmitting information of the predetermined screen to the terminal, and
wherein, in a case where the terminal receives an operation to display the predetermined screen, the at least one processor controls the apparatus to transmit the information of the predetermined screen to the terminal without displaying the predetermined screen on the first display unit.

14. The apparatus according to claim 12, wherein the predetermined screen is a screen to input security information.

15. The apparatus according to claim 12, wherein the predetermined screen is a screen on which a password is displayed.

16. The apparatus according to claim 12,
wherein, in the display control, in a case where the apparatus receives an operation to display the predetermined screen, the at least one processor controls the apparatus to display the predetermined screen on the first display unit and controls the terminal to display a screen different from the predetermined screen on the second display unit, and
wherein, in a case where the terminal receives an operation to display the predetermined screen, the at least one processor controls the terminal to display the predetermined screen on the second display and controls the apparatus to display a screen different from the predetermined screen on the first display unit.

17. The apparatus according to claim 12, wherein the screen different from the predetermined screen displays a notice indicating that another apparatus is receiving an operation.

18. The apparatus according to claim 12, wherein the apparatus functions as a VNC server, and the terminal functions as a VNC client.

19. A method performed by a system comprising an information processing apparatus including a first display unit and a terminal including a second display unit, the method comprising:
performing display control of screens to be displayed on the first display unit and the second display unit, and
wherein a first display control and a second display control are switchable in the display control, the first display control controlling a predetermined screen including secure information to be displayed on the first display unit and not to be displayed on the second display unit, and the second display control controlling the predetermined screen including the secure information to be displayed on the second display unit and not to be displayed on the first display unit.
